(19) United States
(12) Patent Application Publication
(10) Pub. No.: US 2020/0145484 A1
(43) Pub. Date: May 7, 2020

(54) SUB-GROUPS OF REMOTE COMPUTING DEVICES WITH RELAY DEVICES

(71) Applicant: HEWLETT-PACKARD DEVELOPMENT COMPANY, L.P., Spring, TX (US)

(72) Inventors: Joao Luis Prauchner, Porto Alegre (BZ); Derek Lukasik, Fort Collins, CO (US); Reynaldo Cardoso Novaes, Porto Alegre (BZ); Thiago Lottici, Porto Alegre (BZ); Lucia Maciel, Porto Alegre (BZ)

(73) Assignee: HEWLETT-PACKARD DEVELOPMENT COMPANY, L.P., Spring, TX (US)

(21) Appl. No.: 16/473,348

(22) PCT Filed: Feb. 3, 2017
(86) PCT No.: PCT/US2017/016511

§ 371 Date: Jun. 25, 2019

(51) Int. Cl. H04L 29/08; G06F 15/173; H04W 76/14; H04W 76/15; H04W 84/18

(52) U.S. Cl. CPC H04L 67/1076; G06F 15/173; H04W 76/14; H04W 92/02; H04W 84/18; H04L 67/1087; H04W 76/15

(57) ABSTRACT

In example implementations, a method to create sub-groups of remote computing devices is provided. The method includes establishing, via a processor of a sending machine: a respective connection to a plurality of remote computing devices. The processor groups the plurality of remote computing devices into a plurality of sub-groups based on a common network. The processor identifies a remote computing device as a relay device within each one of the plurality of sub-groups having a best connection to the sending machine within a respective sub-group. Then a connection of remaining remote computing devices that are not identified as the relay device are redirected by the processor to the remote computing device that is identified as the relay device within the respective sub-group.

### BACKGROUND

Communication networks have improved over the years to allow computing devices to communicate with other computing devices. The communication networks have improved efficiency and productivity in all areas of life. The computing devices can transmit data at a relatively high rate over the communication networks.

Consequently, the communication networks can be used to allow computing devices to collaborate with one another in real-time. For example, one computing device may host a session and other may be able to interact with the host. As a result, remote users can collaborate to share ideas, contribute to a single design, and the like.

### BRIEF DESCRIPTION OF THE DRAWINGS

FIG. 1 is a block diagram of an example communication network of the present disclosure;

FIG. 2 is a detailed block diagram of the example sender device of the present disclosure;

FIG. 3 is a block diagram of an example method for creating a plurality of sub-groups with respective relay devices;

FIG. 4 is a block diagram of an example method for continuously monitoring the plurality of sub-groups; and

FIG. 5 is a block diagram of a non-transitory computer readable medium storing instructions executed by a processor.

### DETAILED DESCRIPTION

The present disclosure discloses methods and apparatuses for creating a plurality of sub-groups with respective relay devices. As discussed above, some communication networks can be used to allow computing devices to collaborate with one another in real-time. For example, one computing device may host a session and others may be able to interact with the host. As a result, remote users can collaborate to share ideas, contribute to a single design, and the like.

Some collaboration projects may include large amounts of data related to a computer aided design (CAD) drawing, audio signals, video signals and the like. Some collaboration projects occur in real-time. As a result, when large amounts of data are being transmitted to multiple remotely located computing devices for viewing, some computing devices may experience a severe lag due to slow connection speeds relative to the other remotely located computing devices.

The examples of the present disclosure provide a method and an apparatus that creates a plurality of sub-groups with respective relay devices. For example, the remotely located computing devices may be divided into sub-groups based on a location or within a common subnet. Within each one of the sub-groups, one of the computing devices may be identified as a relay device. The remaining computing devices may disconnect from a sending machine that hosts the remote collaboration session and re-connect to the relay device. The relay device may be selected based on the computing device within a sub-group that has the lowest latency. As a result, the data associated with the remote collaboration session may be sent to the relay device and the speed of transmitting the data within a local network via the relay device may be faster than sending the data to each computing device individually. Thus, the delay or lag for the computing devices should be minimized and the overall user experience for collaborative projects should be improved.

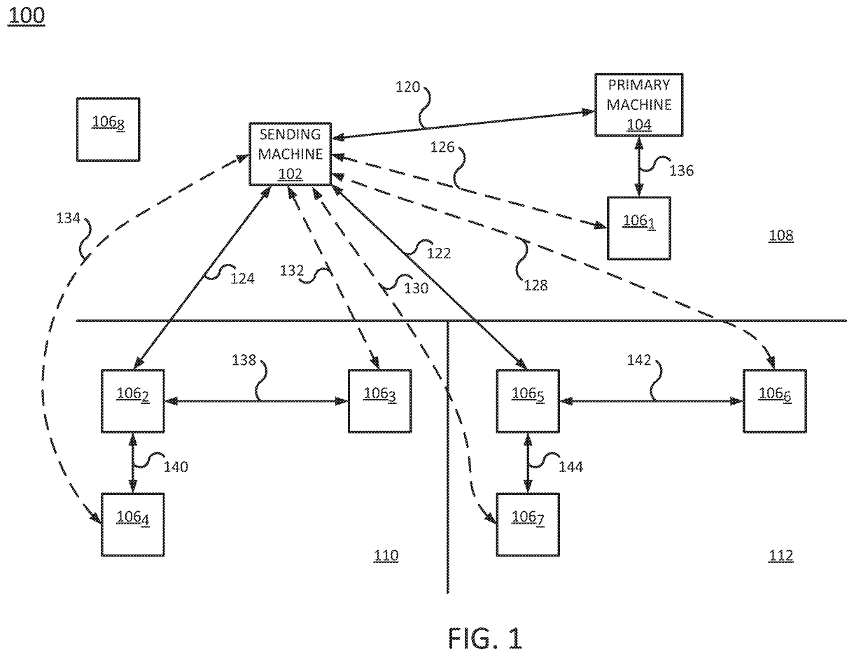

FIG. 1 illustrates a block diagram of an example communication network 100 of the present disclosure. The communication network 100 may include a sending machine 102, a primary machine 104 and a plurality of computing devices 106₁-106₆ (also referred to collectively as “computing devices 106”). Although eight computing devices are shown in FIG. 1, it should be noted that the communication network 100 may include any number of computing devices.

In one example, the sending machine 102, the primary machine 104 and the computing devices 106 may be any type of device that includes a processor and a memory. For example, the sending machine 102, the primary machine 104 and the computing devices 106 may be a desktop computer, a laptop computer, a tablet computer, a smart phone, and the like.

The primary machine 104 may be located with the sending machine 102 or may be located remotely from the sending machine 102. The computing devices 106 may be remotely located from the sending machine 102. For example, the computing devices 106 may be in a different geographic location or different building than the sending machine 102.

It should be noted that the communication network 100 has been simplified for ease of explanation. For example, the communication network 100 may include additional network elements and access networks that are not shown. For example, the communication network 100 may include gateways, routers, switches, firewalls, core Internet protocol (IP) networks/service providers and access networks, such as, a cellular network, a broadband network, local IP networks, and the like.

In one example, the sending machine 102 may host a collaborative project. For example, the primary machine 104 may initiate a session to work on a CAD drawing with the computing devices 106₁-106₇. The session may include live video of each user, audio of each user, input controls to and from the CAD drawing program on the sending machine 102, and the like. In one implementation, the primary machine 104 may send a notification to the computing devices 106₁-106₇ that a collaborative project session is beginning on the sending machine 102. The notification may include a link or information that can be used to have each computing device 106₁-106₇ connect to the sending machine 102.

In one implementation, the primary machine 104 and each computing device 106₁-106₇ may establish a respective connection to the sending machine 102 via a wired or wireless connection. In other words, the “connection” may be a communication path that is established via a physical connection or a wireless connection. The respective connections are illustrated by lines 120, 122 and 124 and dashed lines 126, 128, 130, 132 and 134. The computing devices 106₁-106₇ may provide an IP address or subnet with each connection to the sending machine 102. Based on the IP address or subnet the sending machine 102 may create a plurality of sub-groups of computing devices based on a common network.

Some computing devices 106₁-106₇ may be located together within the common network based on a sub net of the computing devices 106₁-106₇. For example, the primary machine 104 and the computing device 106₁ may be part of a sub-group 108 based on having the same sub net, the computing devices 106₂-106₄ may part of a sub-group 110 based on having the same sub net and the computing devices 106₅-106₇ may part of a sub-group 112 based on having the same sub net. It should be noted that although three sub-groups are illustrated in FIG. 1, that any number of sub-groups may be deployed.

Using the respective connection to each computing device 106₁-106₇, the sending machine 102 may determine which computing devices 106₁-106₇ within each sub-group 108, 110 and 112 have the lowest latency or the highest bandwidth. For example, the sending machine 102 may ping each of the computing devices 106₁-106₇ to determine a connection speed to each one of the computing devices 106₁-106₇.

The sending machine 102 may identify a relay device within each sub-group 108, 110 and 112 based on the latency or the bandwidth. For example, the sending machine 102 may determine that the primary machine 104, the computing device 106₂ and the computing device 106₅ have the lowest latency within their respective sub-groups 108, 110 and 112. Thus, the primary machine 104, the computing device 106₂ and the computing device 106₅ may maintain their respective connections (illustrated by solid lines 120, 122 and 124) to the sending machine 102.

The sending machine 102 may then notify or instruct each remaining computing device 106₁, 106₃, 106₄, 106₆ and 106₇ to disconnect from the sending machine 102 and connect to the relay device within their respective sub-groups 108, 110 and 112. For example, the disconnections of the remaining computing devices 106₁, 106₃, 106₄, 106₆ and 106₇ are illustrated in FIG. 1 by the dashed lines 126, 128, 130, 132 and 134. The subsequent connections to the respective relay device is illustrated by solid lines 136, 138, 140, 142 and 144.

For example, the computing device 106₁ may establish a connection 136 to the primary machine 104 that is identified as the relay device for the sub-group 108. The computing devices 106₃ and 106₄ may establish respective connections 138 and 140 to the computing device 106₂ that is identified as the relay device for the sub-group 110. The computing devices 106₆ and 106₇ may establish respective connections 142 and 142 to the computing device 106₅ that is identified as the relay device for the sub-group 112.

As a result, the sending machine 102 may send data directly to the identified relay devices within the sub-groups 108, 110 and 112. The relay device within the sub-groups 108, 110 and 112 may then send the data over a fast local network or a fast local portion of a larger network to the computing devices 106 within the respective sub-groups 108, 110 and 112.

In some implementations, the sending machine 102 may continuously monitor the connections to the computing devices 106₁-106₇ or new connections to new computing devices. The sending machine 102 may change relay devices within a sub-group 108, 110 or 112 as the latency or bandwidth values for the computing devices 106₁-106₇ change over time.

For example, network conditions within the sub-groups 108, 110 and 112 may change over time. A computing device that is not part of the collaborative project may have been consuming a large amount of network bandwidth that negatively affected the connection speed of the computing device 106₃.

The sending machine 102 may periodically ping all of the computing devices 106₁-106₇ after the sub-groups 108, 110 and 112 have been formed, the relay devices have been identified and the connections of the remaining computing devices have been disconnected and re-established with the relay devices. For example, periodically may include any amount of pre-defined amount of time such as, every 30 seconds, every five minutes, and the like. In an example, the sending machine 102 may periodically send collaborative project data directly to the otherwise indirectly connected computing devices to determine their latency or bandwidth.

At a later time after pinging or directly delivering data to all of the computing devices 106₁-106₇, the sending machine 102 may detect that the computing device 106₃ has a lower latency or higher bandwidth than the computing device 106₂ that was previously identified as the relay device. As a result, the sending device 102 may automatically identify the computing device 106₃ as the new relay device for the sub-group 110. Thus, the computing device 106₃ may connect directly to the sending machine 102. The computing device 106₂ may disconnect from the sending machine 102 and connect directly to the computing device 106₃ that is identified as the new relay device. The computing device 106₄ may disconnect from the computing device 106₂ and connect to the computing device 106₃.

In some implementations, the sending machine 102 may have a pre-defined amount of time to allow the change of the relay device. For example, if the latency or higher bandwidth values are continuously changing between two computing devices 106, then the constant process of connections and disconnections can be disruptive. As a result, to maintain some stability, the sending machine 102 may allow the change to the new relay device if a new relay device has not been identified within the pre-defined amount of time (e.g., within the last 30 minutes, within the last hour, and the like). In an example, the sending machine 102 may use a threshold to determine when to change the relay device. For example, the sending machine 102 may determine whether the difference in the latency or bandwidth is more than the threshold. In an example, the sending machine 102 may compare the latency or bandwidth a plurality of times and change the relay device based on all or a predetermined percentage of the comparisons favoring a change (e.g., 50%, 60%, 70%, 80%, 90%, etc.). In another implementation, the sending machine 102 may change relay devices continuously as latency or bandwidth values change irrespective of how many times a new relay device has been identified within a particular time period.

In some implementations, the relay device that is identified may disconnect from the sending machine 102. For example, the computing device 106₅ may have to leave the collaboration project session and disconnect from the sending machine 102. The sending machine 102 may detect the disconnection and notify the computing devices 106₆ and 106₇ to reconnect directly to the sending machine 102. The sending machine 102 may then compute the latency values for the computing devices 106₆ and 106₇ and identify a new relay device.

In some implementations, when a relay device disconnects from the sending machine 102, the sending machine may instruct all remaining computing devices 106 to re-connect directly to the sending machine 102. The process of creating the sub-groups 108, 110, 112, calculating the latency of each respective connection to the remaining computing devices 106 and identifying a relay device within each sub-group 108, 110 and 112 may be repeated.

In some implementations, a new computing device 106₈ may connect to the sending machine 102. When a new computing device 106a connects to the sending machine 102, the sending machine 102 may identify the subnet of the computing device 106₈ and identify which sub-group 108, 110, 112, or a new sub-group, to assign to the computing device 106₈. The sending machine 102 may then calculate the latency to the computing device 106₈ and determine if the latency is lower than the latency of the relay device in the sub-group 108, 110, 112, or a new sub-group that was assigned to the computing device 106₈.

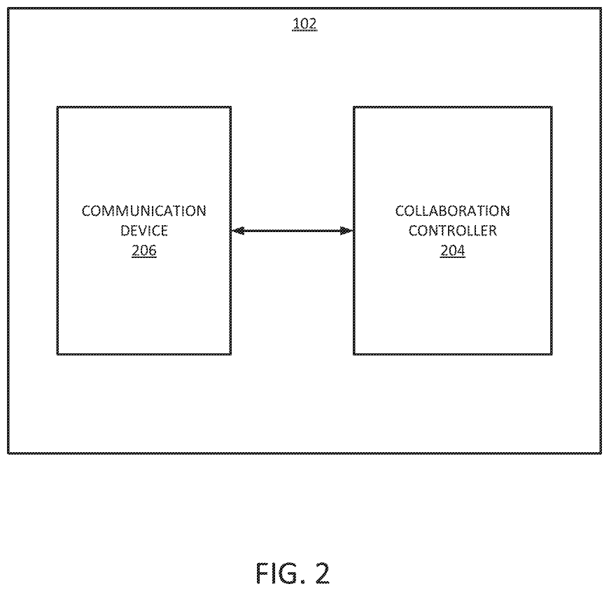

FIG. 2 illustrates a block diagram of an example of the sender device 102. In one implementation, the sender device 102 may include a communication device 206 and a collaboration controller 204. The communication device 206 may include an interface for wired or wireless communications with the computing devices 106. For example, the communication device 206 may be a network interface card that includes an Ethernet port or a wireless communication module to communicate with a wireless route. The communication device 206 may establish a respective connection to the plurality of remote computing devices 106.

The collaboration controller 204 may include a processor that communicates with the collaboration controller 204. The collaboration controller 204 may also include local memory to temporarily store and manage the created sub-groups 108, 110 and 112, the latency values associated with each computing device 106, which computing devices 106 are currently connected, the identified relay devices, and the like.

In one implementation, the collaboration controller 204 communicates with each one of the computing devices 106 that are remotely located via respective connections that are established via the communication device 206. The collaboration controller 204 may use the established connections to measure a latency (e.g., via a pinging process) or bandwidth and to receive a subnet or an IP address of each one of the computing devices 106. The collaboration controller 204 may group the plurality of computing devices 106 into the sub-groups 108, 110 and 112 based on the subnet or an IP address of each one of the computing devices 106. The collaboration controller 204 may then identify a computing device 106 that has the lowest latency or highest bandwidth within a respective sub-group 108, 110 and 112 as a relay device for that sub-group 108, 110 or 112.

Once the relay device is identified, the collaboration controller 204 may notify all remaining computing devices 106 that are not identified as a relay device to connect to the relay device within the respective sub-group 108, 110 or 112. The collaboration controller 204 may wait for a confirmation that the connections to the respective relay device are established and then drop the connection to the remaining remote computing device.

In one implementation, the collaboration controller 204 may periodically ping or transfer data directly to the computing devices 106 to obtain a current latency or bandwidth of each one of the computing devices 106. For example, the collaboration controller 204 may temporarily re-establish a connection to all of the computing devices 106 to obtain or measure the current latency or bandwidth.

In some implementations, the collaboration project or session being hosted by the sending machine 102 may be in real-time. Thus, the collaboration controller 204 may synchronize image data (e.g., real-time video of the users of the computing devices 106 and the primary machine 104), CAD data, and the like based on the measured latency values of the relay devices that are in communication with the sending machine 102. In other words, the image data (e.g., the video) may be delayed to the computing devices 106 identified as a relay device having faster connections while the video is being relayed to the other computing devices 106 within a sub-group 108, 110 and 112. The amount of delay at each relay device may be calculated based on respective latency and bandwidth values. For example, each computing device 106 that is identified as a relay device may have a different amount of delay due to different latency or bandwidth values. As a result, lag between the relay devices connected to the sending machine 102 should be minimized.

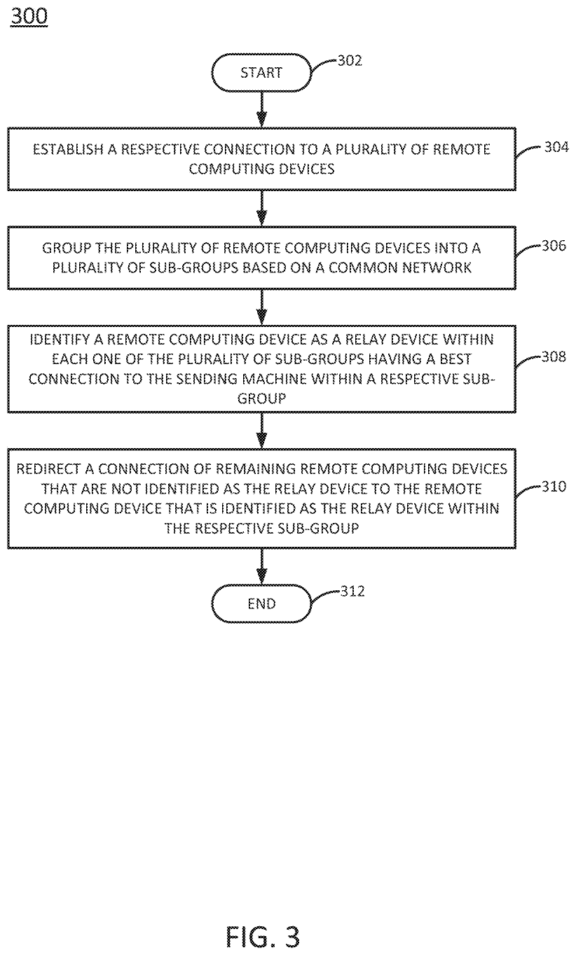

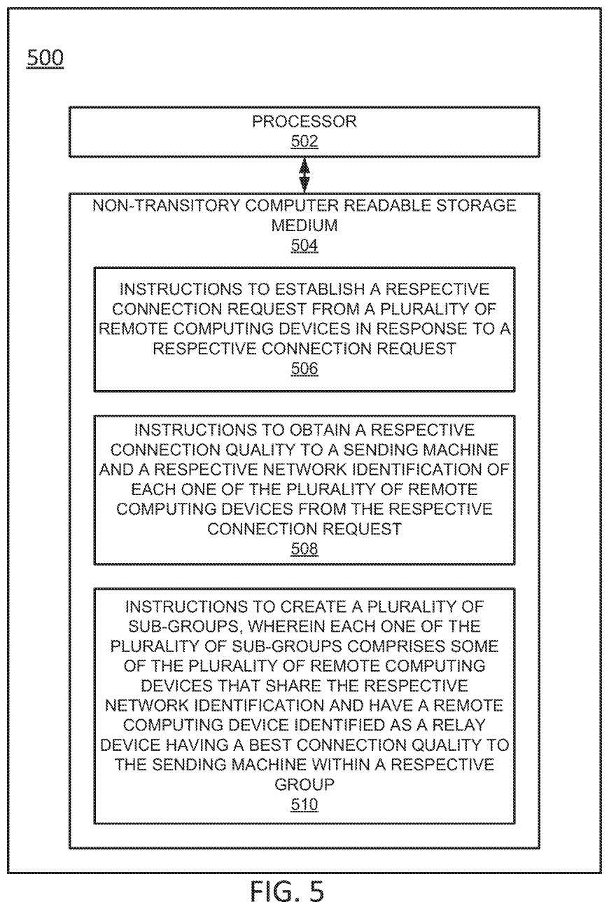

FIG. 3 illustrates a flow diagram of an example method 300 for creating a plurality of sub-groups with respective relay devices. In one example, the method 300 may be performed by the sending machine 102 illustrated in FIGS. 1 and 2, or the apparatus 500 described below in FIG. 5.

At block 302, the method 300 begins. At block 304, the method 300 establishes a respective connection to a plurality of remote computing devices. For example, a primary machine may initiate a collaboration project or session on the sending machine. The primary machine may then send a notification or message to a plurality of remote computing devices with information on how to connect to the sending machine (e.g., a link, an IP address of the sending machine, and the like) via the sending machine. In another example, the primary machine may send the notification directly to the remote computing devices.

The sending machine may then establish the respective connection to each one of the remote computing devices. For example, each remote computing device may request a connection to the sending device based on the information that was sent to the remote computing device.

At block 306, the method 300 groups the plurality of remote computing devices into a plurality of sub-groups based on a common network. In one example, when establishing the connection to the remote computing devices, each remote computing device may provide information to the sending machine about the respective computing device. For example, each computing device may provide network information to the sending machine. The network information may include an IP address, a subnet, a geographic location, and the like.

In one example, the computing devices may be arranged, or created, into sub-groups based on the subnet, the IP address, the geographic location, etc. For example, it may be assumed that computing devices within the same subnet may be within a common local area network. As a result, the connection speeds between the computing devices within the same subnet may be faster than the connection speed to the sending machine.

At block 308, the method 300 identifies a remote computing device as a relay device within each one of the plurality of sub-groups having a best connection to the sending machine within a respective sub-group. In one example, the best connection may be based on the latency or bandwidth between the sending machine and each one of the remote computing devices may be measured. For example, the sending machine may perform a pinging operation over the respective established connections to each one of the remote computing devices to obtain the respective latency or bandwidth values.

The remote computing device within a respective sub-group having the lowest latency or highest bandwidth may be identified as having the best connection and be identified as the relay device. The relay device may remain connected directly to the sending machine and be responsible for forwarding all data received from the sending machine to the other computing devices within the respective sub-group.

At block 310, the method 300 redirects a connection of remaining remote computing devices that are not identified as the relay device to the remote computing device that is identified as the relay device within the respective sub-group. For example, the sending machine may notify the remaining computing devices that are not identified as the relay device to establish a connection to the relay device within the respective sub-group. The sending machine may wait for a confirmation that the connection to the relay device has been established and then drop the connection to the remaining computing devices that are not identified as the relay device. At block 312, the method 300 ends.

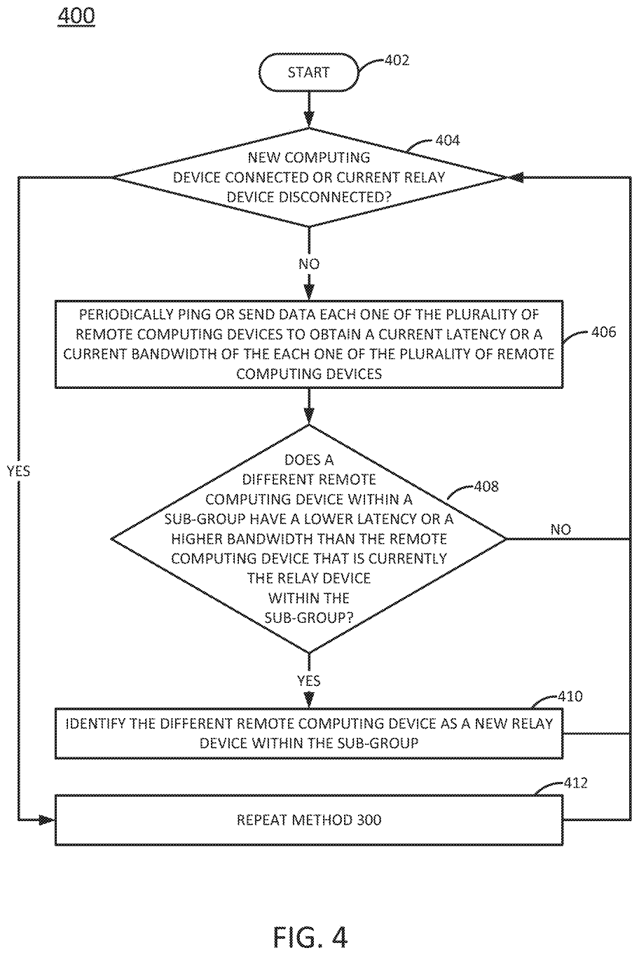

FIG. 4 illustrates a flow diagram of an example method 400 for continuously monitoring the plurality of sub-groups. In one example, the method 400 may be performed by the sending machine 102 illustrated in FIGS. 1 and 2, or the apparatus 500 described below in FIG. 5.

At block 402, the method 400 begins. At block 404, the method 400 determines if a new computing device is connected or a current relay device has disconnected. For example, after the initial sub-groups are created and the initial relay devices are identified in the method 300 above, new computing devices may try to connect to the sending machine or a relay device may disconnect from the sending machine.

If the answer to block 404 is yes, the method 400 may proceed to block 412 where the method 400 repeats method 300 described above in FIG. 3. The method 400 may then loop back to block 404. In some implementations, when a new computing device is connected, the method 400 may simply assign the new remote computing device to one of the sub-groups that have been created and determine the latency or bandwidth of the connection to the new remote computing device. The new remote computing device may be identified as a new relay device if the latency is lower than the latency to the currently identified relay device within the respective sub-group or the bandwidth is higher.

If the answer to block 404 is no, the method 400 may proceed to block 406. At block 406, the method 400 periodically pings or sends data to each one of the plurality of remote computing devices to obtain a current latency or bandwidth of each one of the plurality of remote computing devices. For example, the sending machine may have the information for each computing device from the initial connection to temporarily re-establish a connection to measure the current latency or bandwidth.

At block 408, the method 400 determines if a different remote computing device within a sub-group has a lower latency or a higher bandwidth than the remote computing device that is currently the relay device within the sub group. For example, a first remote computing device may have been initially identified as the relay device within a first sub-group. At a later time, the sending machine may determine that a second remote computing device within the first sub-group has a lower latency or higher bandwidth than the first remote computing device.

If the answer to block 408 is no, the method 400 may loop back to block 404 and continue to monitor the plurality of sub-groups. However, if the answer to block 408 is yes, the method 400 may continue to block 410. At block 410, the method 400 identifies the different remote computing devices as the new relay device within the sub-group.

Using the example described above in block 408, the second remote computing device with the lower current latency or higher current bandwidth may be identified as the new relay device. As a result, the second remote computing device may establish a connection directly to the sending machine. The first remote computing device and the remaining remote computing devices (if any) in the first sub-group may connect directly to the second remote computing device. The first remote computing device may then disconnect from the sending machine.

The method 400 may then loop back to block 404 to continuously monitor the plurality of sub-groups. In one implementation, the method 400 may continuously loop until the collaboration session that is hosted by the sending machine is ended.

FIG. 5 illustrates an example of an apparatus 500. In one example, the apparatus may be the sending machine 102. In one example, the apparatus 500 may include a processor 502 and a non-transitory computer readable storage medium 504. The non-transitory computer readable storage medium 504 may include instructions 506, 508, and 510 that when executed by the processor 502, cause the processor 502 to perform various functions.

In one example, the instructions 506 may include instructions to establish a respective connection request from a plurality of remote computing devices in response to a respective connection request. The instructions 508 may include instructions to obtain a respective connection quality to a sending machine and a respective network identification of each one of the plurality of remote computing devices from the respective connection request. For example, the respective connection quality to the sending machine may be based upon latency or bandwidth values that are obtained from each one of the plurality of remote computing device. The respective network identification may include a respective subnet, IP address, or geographic location of each one of the plurality of remote computing devices. The instructions 510 may include instructions to create a plurality of sub-groups, wherein each one of the plurality of sub-groups comprises some of the plurality of remote computing devices that share the respective network identification and have a remote computing device identified as a relay device having a best respective connection quality to the sending machine within a respective sub-group.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method, comprising:
establishing, via a processor of a sending machine, a respective connection to a plurality of remote computing devices;
grouping, by the processor, the plurality of remote computing devices into a plurality of sub-groups based on a common network;
identifying, by the processor, a remote computing device as a relay device within each one of the plurality of sub-groups having a best connection to the sending machine within a respective sub-group; and
redirecting, by the processor, a connection of remaining remote computing devices that are not identified as the relay device to the remote computing device that is identified as the relay device within the respective sub-group.

2. The method of claim 1, wherein the grouping comprises:
identifying, by the processor, the common network based on a subnet of each one of the plurality of remote computing devices;
creating, by the processor, the plurality of sub-groups based on the subnet of the each one of the plurality of remote computing devices.

3. The method of claim 1, comprising:
periodically pinging, by the processor, each one of the plurality of remote computing devices to obtain a current latency or a current bandwidth of the each one of the plurality of remote computing devices.

4. The method of claim 3; comprising:
determining, by the processor, that a different remote computing device within a sub-group has a lower latency than the remote computing device that is currently the relay device; and
identifying, by the processor, the different remote computing device as a new relay device within the sub-group.

5. The method of claim 1, comprising:
establishing, by the processor, a new connection to a new remote computing device;
assigning, by the processor, the new remote computing device to one of the plurality of sub-groups; and
determining, by the processor, a latency or a bandwidth of the new remote computing device.

6. The method of claim 5, comprising:
connecting, by the processor, the new remote computing device to the relay device of the respective sub-group when the latency is higher or the bandwidth is lower than the remote computing device that is currently the relay device.

7. The method of claim 5, comprising:
identifying, by the processor, the new remote computing device as the relay device of the respective sub-group when the latency is lower or the bandwidth is higher than the remote computing device that is currently the relay device.

8. The method of claim 1, comprising:
detecting, by the processor, that the remote computing device that is currently the relay device has disconnected; and
notifying, by the processor, the remaining remote computing devices to re-connect to the sender machine to repeat the identifying and the redirecting.

9. An apparatus, comprising:
a communication device to establish a respective connection to a plurality of remote computing devices; and
a collaboration controller in communication with the communication device to measure a latency and receive a subnet of each one of the plurality of remote computing devices, group the plurality of remote computing devices into a plurality of sub-groups based on the subnet of the each one of the remote computing devices, identify a remote computing device as a relay device within each one of the plurality of sub-groups having a having a best connection to a sending machine within a respective sub-group, notifying all remaining remote computing devices that are not identified as the relay device to connect to the relay device within the respective sub-group and dropping the connection to the all remaining remote computing device.

10. The apparatus of claim 9, the communication device to periodically ping each one of the plurality of remote computing devices to obtain a current latency or a current bandwidth of the each one of the plurality of remote computing devices.

11. The apparatus of claim 9, wherein the collaboration controller synchronizes image data that is sent to the remote computing device that is identified as the relay device in the respective sub-group of each one of the plurality of sub-groups.

12. A non-transitory computer readable storage medium encoded with instructions executable by a processor of a sender machine, the non-transitory computer-readable storage medium comprising:
instructions to establish a respective connection request from a plurality of remote computing devices in response to a respective connection request;
instructions to obtain a respective connection quality to a sending machine and a respective network identification of each one of the plurality of remote computing devices from the respective connection request; and
instructions to create a plurality of sub-groups, wherein each one of the plurality of sub-groups comprises some of the plurality of remote computing devices that share the respective network identification and have a remote computing device identified as a relay device having a best respective connection quality to the sending machine within a respective sub-group.

13. The non-transitory computer readable storage medium of claim 12, comprising:
instructions to periodically ping each one of the plurality of remote computing devices to obtain a current latency or a current bandwidth of the each one of the plurality of remote computing devices;
instructions to determine that a different remote computing device within a sub-group has a lower latency or a higher bandwidth than the remote computing device that is currently the relay device; and
instructions to identify the different remote computing device as a new relay device within the sub-group.

14. The non-transitory computer readable storage medium of claim 12, comprising:
instructions to establish a new connection to a new remote computing device;
instructions to assign the new remote computing device to one of the plurality of sub-groups;
instructions to determine a latency or a bandwidth of the new remote computing device; and
instructions to connect the new remote computing device to the relay device of the respective sub-group when the latency is higher or the bandwidth is lower than the remote computing device that is currently the relay device and identify the new remote computing device as the relay device of the respective sub-group when the latency is lower or the bandwidth is higher than the remote computing device that is currently the relay device.

15. The non-transitory computer readable storage medium of claim 12, comprising:
instructions to detect that the remote computing device that is currently the relay device has disconnected; and
instructions to notify the remaining remote computing devices to re-connect to the sender machine to repeat the identifying and the redirecting.
